(19) United States
(12) Patent Application Publication
(10) Pub. No.: US 2010/0196734 A1
(43) Pub. Date: Aug. 5, 2010

(54) WEAR PROTECTION SHEETS, PROCESSES FOR PRODUCING THE SAME, AND USES THEREOF

(75) Inventors: Michael Svec, Schonwald (DE); Karl-Hermann Buchner, Hof (DE); Hans-Peter Baldus, Koditz (DE); Aloys Eiling, Bochum (DE); Jim Ryan, West Chester, OH (US)

Correspondence Address: CONNOLLY BOVE LODGE & HUTZ, LLP, P O BOX 2207, WILMINGTON, DE, 19899, US

(73) Assignees: H.C. Starck Ceramics GmbH & Co. KG; H.C. Starck Inc., Newton, MA (US)

(21) Appl. No.: 12/575,753

(22) Filed: Oct. 8, 2009

Related U.S. Application Data
(60) Provisional application No. 61/104,095, filed on Oct. 9, 2008.

(51) Int. Cl. B32B 15/02; B22F 1/00; B05D 3/02; B29C 65/48

(52) U.S. Cl. 428/548; 75/230; 75/239; 75/240; 75/236; 75/244; 419/65; 419/10; 427/376.6; 156/60

(57) ABSTRACT

Wear protection sheets containing hard material particles having a metallic shell and solder material particles selected from the group consisting of soft solders, hard solders and high-temperature solders, the use of the wear protection sheets and a process for producing them by tape casting are described.

### CROSS-REFERENCE TO RELATED APPLICATIONS

This application claims benefit of priority under 35 U.S.C. §119(e) of U.S. provisional patent application Ser. No. 61/104,095, filed on Oct. 9, 2008, the entires contents of which are incorporated herein by reference.

### BACKGROUND OF THE INVENTION

Coating with hard material alloys is gaining increasing importance for protection against high wear stress, in particular by means of abrasion. The application of wear protection sheets to mechanically stressed components also protects against corrosion or thermal damage. In this way, the life of such components can be considerably increased and the operating costs can be significantly reduced. In particular, composites known as metal-matrix composites (MMCs), comprising a tough nickel, cobalt or iron metal matrix in which hard materials such as carbides, borides or nitrides are embedded, are employed. A very good homogeneous distribution of the hard materials in the metal melt and good bonding between hard material and solder is of great importance for the quality of the resulting wear protection layers. The distribution of the hard materials and the formation of the interface between hard material and solder and the formation of reaction phases in a molten metal alloy depend greatly on the materials to be mixed, the desired proportion of hard materials or the proportion of the metal matrix in the cemented hard material alloy and the process conditions during the manufacturing process. For this reason, there continues to be a search for reliable and simple processes for producing such wear protection materials or wear protection coatings.

Thus, for example, U.S. Pat. No. 6,649,682 B1 describes the application of an aqueous dispersion containing hard carbide particles to the surface to be upgraded, followed by treatment with a dispersion containing solder materials, with the wear protection layer subsequently being formed by heating the surface of the component which has been treated in this way.

U.S. Pat. No. 5,594,931 describes the production of prefabricated wear protection materials which comprise at least two layers having different proportions of hard material and solder material, with the layers being firmly joined by sintering.

US 2007/0017958 A1 describes multilayer wear protection materials and also the use of layer-like materials containing hard material particles, a metal alloy, a solder material and optionally a binder. The wear protection materials can be produced by slurrying of the individual constituents in a solvent and subsequent casting of the material to form a layer. An alternative process which can be utilized for producing metallic sheets is described, for example, in WO 2007/147792.

### BRIEF SUMMARY OF THE INVENTION

The present invention relates to wear protection sheets composed of metal-encased hard material particles, in particular nickel-encased tungsten carbides, and solder material particles, in particular nickel-chromium-based solder alloys, a process for producing them using tape casting and their use for producing components having increased operating lives.

The present invention provides wear protection sheets which are easy to produce and simple to handle. Furthermore, the wear protection layers produced on a component by means of these sheets can exhibit a very low porosity, display low abrasion and have a high hardness.

These and other advantages are achieved by means of wear protection sheets which comprise firstly hard material particles which have a metallic shell and secondly a solder material, in particular a hard solder or a high-temperature solder. If appropriate, the wear protection sheets can also contain organic binders and plasticizers.

It has been found that metal-encased hard material particles together with solder material powders can be processed in the presence of a binder suspension containing an organic binder and, if appropriate, a plasticizer to produce a stable slip. The metal-encased hard material particles can be incorporated particularly well into the solder material matrix, with the encasing metal being selected so that it is easily wetted by the solder material. The metals used as hard material particle shell are preferably metals which are also present in the solder material. The improved wettability of the metal-encased hard material particles results in improved incorporation of the particles into the solder material matrix. In addition, the tendency of the solder to react with the hard material can be controlled or avoided by means of a suitable metal shell. This also applies to the further processing steps which are necessary for producing wear protection layers from the wear protection sheets claimed.

The casting of the slip to produce the corresponding wear protection sheet barely influences the distribution of the metal-encased hard material particles in the solder material matrix. This can be attributed to the use of an organic binder as a result of which the good hard material distribution in the metal matrix is stabilized during the process for producing the sheets. Subsequent drying of the sheet or removal of the binder from the sheet at low temperatures below 400° C. likewise has no appreciable influence on the particle distribution of the sheet. The sheet obtained can also be pre-sintered called also as presintered, i.e. the sheet is subjected to a sintering step before it is applied to a component in order to produce the wear protection layer in a subsequent step. The pre-sintering of the sheet reduces the sheet shrinkage during production of wear protection layers on the desired component. However, this does not rule out the possibility of wear protection sheets which have not been pre-sintered or not had the binder removed from them being applied directly to the respective component and then being able to be subjected to binder removal and further treatment. The pre-sintered sheets can also easily be adhesively bonded to a component or soldered or welded onto the component using an additional solder, e.g. by means of flame soldering.

The wear protection sheets described here are thus particularly suitable for application to components by hard soldering or high-temperature soldering, in particular in vacuum furnaces. In the case of pre-sintered wear protection sheets, these can be adhesively bonded on, soldered on or welded on. Even after the high temperatures during sintering, pre-sintering, hard soldering or high-temperature soldering processes, the wear protection layers obtained display a virtually isotropic microstructure in respect of the particle size distribution and a very low porosity, as a result of which low abrasion and high hardness are achieved over the entire area of the component to be upgraded. Pore formation is reduced by the good wettability of the metal-encased hard material particles by the solder material, since good bonding is achieved at the interface between the metal-encased hard material particles and the solder material. In particular, phase reactions or diffusion processes can also occur at the interface between the metal shell of the hard material particle and the solder material during sintering, pre-sintering or soldering, especially when the hard material particles have a metal shell. Such diffusion processes or phase reactions further stabilize the wear protection layer during the production process encompassing a treatment at high temperatures and pore formation in the wear protection layer is minimized. At the same time, reaction of the solder with the hard material can be controlled or reduced by the choice of the metal shell. In addition, the sheets according to the invention can be produced simply and on an industrial scale from a slip by means of conventional tape casting processes.

The present invention thus provides a wear protection sheet containing hard material particles which have a metallic shell and solder material particles selected from the group consisting of soft solders, hard solders and high-temperature solders.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 shows the wear protection layer comprising a NICROBRAZ solder material and tungsten carbide on a steel support as produced in Example 2.1 according to one embodiment of the present invention; and

FIG. 2 shows a pre-sintered particle composite composed of nickel-encased tungsten carbide particles and a nickel/chromium-containing solder material according to one embodiment of the present invention.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a metal” herein or in the appended claims can refer to a single metal or more than one metal. Additionally, all numerical values, unless otherwise specifically noted, are understood to be modified by the word “about.”

The hard material particles preferably contain carbides and/or borides of transition metals having high melting points; these are, in particular, carbides of tungsten, titanium, vanadium, chromium, tantalum, niobium silicon or molybdenum, but borides, carbonitrides or nitrides of these metals are also possible as hard material particles. Particular preference is given to tungsten carbides, e.g. WC and/or FTC (fused tungsten carbides), where FTC is a mixture of WC and W₂C which represents, in particular, a eutectic microstructure composed of WC and W₂C. titanium carbides, e.g. TiC, tantalum carbides, vanadium carbides, e.g. VC, chromium carbides, e.g. Cr₃C₂, Cr₇C₃, Cr₂₃C₅, silicon carbides, e.g. SiC molybdenum carbides, e.g. Mo₂C, or titanium borides, e.g. TiB₂, or mixtures of the hard material particles mentioned, with tungsten carbides, if appropriate mixed with tungsten borides, e.g. WB, being of particular importance. Particularly preferred hard material particles comprise the carbides and/or borides just mentioned.

Very particular preference is given to fused tungsten carbides of the formula W₂C/WC, with the particulate fused carbides having a particle shell composed of tungsten carbide (WC). A particularly preferred fused tungsten carbide having a WC shell is macroline tungsten carbide (MWC, of the Amperweld® powder series from H.C. Starck GmbH). The hard materials described will hereinafter also be referred to as hard metals.

Owing to the high hardness, the use of FTCs (fused tungsten carbides) as hard material particles is of particular interest for the production of wear protection layers. Owing to the strong phase reaction in nickel-based solders, preference is given to using the thermally more stable FTC, viz. macroline tungsten carbide, as hard material. Macroline tungsten carbides have an FTC core and a WC shell which substantially protects the FTC core from reactions with the nickel-based solder.

Furthermore, the use of hard materials in spherical form is possible. Hard materials in spherical form can be obtained, in particular, by gas atomization or are produced from agglomerated hard materials in a plasma.

The hard material particles are surrounded by a metal shell, with the metal shell aiding bonding to the solder material and incorporation into the slurry. The shell preferably has a composition similar to that of the solder material. In particular, metals which are also present in the solder material are present in the shell. Particularly preferred metals of the shell are nickel, cobalt, chromium, iron, copper, molybdenum, aluminum, yttrium or a mixture of these metals. Preferred mixtures of these shell metals are cobalt/chromium, nickel/chromium, nickel/cobalt mixtures. Furthermore, particular preference is given to the use of nickel-encased, chromium-encased or cobalt-encased hard material particles. Metal-encased hard material particles are commercially available, e.g. nickel-encased or cobalt-encased tungsten carbide is marketed by H.C. Starck, Germany. In a particularly preferred embodiment, hard material particles composed of fused tungsten carbides which can bear a WC shell and are encased in a nickel-containing layer are used.

The metal-encased hard materials used are generally present in pulverulent form. Use of made of powders having an average particle diameter of from about 0.05 μm to 200 μm, preferably from 10 μm to 150 μm, with the ideal particle diameter depending on the application. The hard materials are preferably completely coated with a metal shell, but partly metal-coated particles can also be employed. However, preference is given to at least 50% of the surface of the latter particles being provided with a metal coating. The hard material particles are provided with a metal coating by deposition of the metal provided for coating on the hard material particles using conventional processes.

Preferred solders for the purposes of the present invention are hard solders or high-temperature solders. Possible solder materials are, in particular, solder powders from the group consisting of nickel, titanium, cobalt, copper, tin or silver solders. Suitable solders are, for example, hard solders such as copper/tin solders, silver/cadmium/copper solders, silver/phosphorus solders. Particular preference is given to using high-temperature solders such as solders based on nickel or cobalt, e.g. nickel/chromium-containing solders or nickel/cobalt-containing solders. However, it is also possible to use soft solders, in particular soft solders based on tin, e.g. tin/lead or tin/silver solders which can additionally contain further metals such as antimony, bismuth and/or copper. Additions of phosphorus are likewise routine for customary soft solders.

In a particularly preferred embodiment, metal-encased hard material particles are used in combination with nickel-containing solder materials. Particularly nickel solders with additives, e.g. boron, chromium and silicon, can attack hard material particles such as tungsten carbides, in particular fused tungsten carbides, and thus make them ineffective. The use of metal-encased hard material particles enables the dissolution of the hard material in the solder material to be reduced. The encasing of FTCs in a tungsten carbide shell (WC shell), in particular, helps reduce or prevent the dissolution of fused tungsten carbides in nickel based solders. Accordingly, the use of nickel-encased fused tungsten carbides having a WC shell, e.g. MWC, is particularly useful for producing particularly good wear protection layers.

The wear protection sheets described here generally contain, based on the total weight of the sheet, from 5% by weight to 95% by weight, preferably from 10% by weight to 90% by weight, of metal-encased hard material particles and from 5% by weight to 95% by weight, preferably from 10% by weight to 50% by weight, of solder material particles. The sheets particularly preferably contain from 60% by weight to 80% by weight of metal-encased hard material particles and from 20% by weight to 40% by weight of solder material. The mixing ratio of the hard materials and solder materials present can be varied as a function of the respective wear protection application. The solder materials used can be selected on the basis of the desired soldering temperature and on the basis of the material of the component to be coated. The solder materials preferably have a solidus temperature above the decomposition temperature of organic additives used.

The wear protection sheets can also contain hard material particles and/or soldermaterial particles selected from the group consisting of soft solders, hard solders and high-temperature solders, wherein the sheet contains, based on its total weight of
from 0.1% by weight to 99.9% by weight of hard material particles and of
from 0.1% by weight to 99.9% by weight of solder material particles and of
from 0.1% by weight to 20% by weight of organic binders and/or plasticizers.

The wear protection sheets described can also be laminated with further layers containing hard material and/or solder material. Preference is given to laminating two or more sheets according to the invention which are characterized by a different content of metal-encased hard material particles or of solder material to produce a composite sheet.

The present invention therefore further provides composites containing at least one of the wear protection sheets described, with the individual layers of the composite containing different proportions of hard material particles and/or solder material particles. Such composites preferably have a layer having a proportion of from 40% by weight to 95% by weight, particularly preferably from 60% by weight to 90% by weight, of metal-encased hard material particles and from 5% by weight to 60% by weight of solder material. Furthermore, the composites have at least one further layer which comprises predominantly solder material, preferably in a proportion of from 40% by weight to 100% by weight, particularly preferably from 60% by weight to 90% by weight. This layer, too, can contain hard material particles, in particular in a proportion by weight of from 10% to 40%, and these hard material particles are preferably likewise encased in metal. Such composites, too, can be sintered onto the component and/or be pre-sintered. Sintered composites can likewise be adhesively bonded, soldered or welded onto the component in a simple fashion.

In a further embodiment, the composites according to the present invention can have a layer having a proportion of from 0.1% by weight to 99.9% by weight, particularly from 60% by weight to 90% by weight of hard material particles and from 0.1% by weight to 99.9% by weight of solder materials.

In a further embodiment, the wear protection sheets claimed can, apart from other additives, additionally contain organic binders and plasticizers. The proportion of organic binders and plasticizers is from 0 to 20% by weight, based on the total weight of the sheet. Here, organic binders and plasticizers are preferably used in a weight ratio of from 100:0 to 50:50. If an organic binder is present in the wear protection sheet, it is particularly preferably present in a proportion by weight of from 0.5% by weight to 15% by weight, in particular from 2% by weight to 10% by weight, and the plasticizer is particularly preferably present in a proportion by weight of from 0.1% by weight to 10% by weight, in particular from 0.5% by weight to 5% by weight, based on the total weight of the sheet.

Preferred organic binders and plasticizers are ones which decompose at temperatures below 400° C., preferably below 350° C. Suitable organic binders are, for example, polymers having a low ceiling temperature, e.g. halogenated polyolefins, in particular Teflon, polyacetals, polyacrylates or polymethacrylates or copolymers thereof, polyalkylene oxides, polyvinyl alcohols or derivatives thereof, polyvinyl acetates or polyvinyl butyrals. Particular preference is given to organic binders from the group consisting of polyalkylene carbonates, in particular polypropylene carbonate. The organic binder serves, in particular, to bind together the individual solid particles during drying. The binder should be readily soluble in the solvent and be compatible with further additives, e.g. dispersants. It is advantageous for the addition of the binder not to bring about an appreciable increase in the viscosity of the slip and to have a stabilizing effect on the suspension. The organic binder should preferably burn out without leaving a residue at low temperatures below 400° C. In addition, the binder ensures better keeping qualities and improved handleability of the green sheet, in particular reduces the formation of cracks, for example during drying.

Suitable plasticizers are, for example, phthalates such as benzyl phthalate, glues, waxes, gelatins, dextrins, gum arabic, oils such as paraffin oil or polymers such as polyalkylenes, in particular polyethylene. However, preferred plasticizers are alkylene carbonates, in particular propylene carbonate. The plasticizer should, in particular, reduce the glass transition temperature of the polymeric binder and increase the flexibility of the green sheet. The plasticizer penetrates into the network structure of the binder and thus reduces the viscosity of the slip. Setting a suitable binder/plasticizer ratio and combining various binders and plasticizers enable, for example, the ultimate tensile strength and extensibility of the green sheets to be influenced. The plasticizers used also preferably burn out completely at low temperatures below 400° C.

Further additives which can be present in the sheets are metallic binders such as metal powders which can preferably contain tungsten, tantalum, niobium, molybdenum, chromium, vanadium, titanium, manganese, iron, cobalt, nickel, copper, zinc, silver, cadmium, aluminum or tin. Metal oxides such as silicates, aluminum oxide, zirconium oxide or titanium oxide can also be added. Such metallic additives should not exceed a proportion of 30% by weight of the total weight of the wear protection sheet.

The wear protection sheets of the invention can be flat sheets or sheets having a three-dimensional shape. The layer thickness of the sheets is in the range from 10 μm to 3000 μm, in particular from 50 μm to 2500 μm, preferably from 200 μm to 2000 μm.

The present invention further provides a tape casting process for producing wear protection sheets which is simple to carry out industrially and is accordingly inexpensive. For this purpose, a binder dispersion containing at least one solvent and an organic binder is firstly prepared.

As solvents, it is possible to use, in particular, organic solvents. However, the addition of water can also be advantageous in particular cases. Preferred solvents are, for example, esters, ethers, alcohols or ketones, in particular methanol, ethanol, propanol, butanol, diethyl ether, butyl methyl ether, methyl acetate, ethyl acetate, acetone, methyl ethyl ketone (MEK) or mixtures thereof. Particularly preferred solvents are ketones, in particular from the group consisting of alkyl ketones. As organic binders, preference is given to using the compounds mentioned further above, in particular polyalkylene carbonates. Furthermore, a plasticizer can also be added directly to the binder suspension. The mixture obtained is mixed and homogenized in a mixing apparatus, e.g. a ball mill.

The binder suspension produced in this way is then admixed with the hard material particles which have a metallic shell and the solder material and processed to give a slip. This can, for example, be effected in a tumble mixer or in a ball mill, with the ball mill being filled with milling media which preferably have a density higher than that of the hard material particles to be processed. The binder suspension is preferably initially placed in the ball mill, but can also be added subsequently. Furthermore, the metal-encased hard material powder and the solder material powder are introduced into the ball mill and the mixture obtained is milled and stirred until a stable slip is formed. When a ball mill is used, sufficient mixing and homogenization of the slip generally takes from 4 hours to 48 hours. The slip can subsequently be degassed under reduced pressure. Storage, degassing and other processing steps are preferably carried out with continual stirring in order to prevent sedimentation of the solid constituents of the slip.

In alternative embodiments, it is naturally also possible to prealloy the hard material and/or solder material particles and add the binder suspension. Continuous or stepwise addition of the binder suspension during production of the slip is also conceivable.

The slip obtained can then be cast to produce a sheet by means of conventional tape casting processes.

To produce the slurry, preference is given to using from 5% by weight to 60% by weight, preferably from 10% by weight to 30% by weight, of the binder suspension, based on the total weight of the slip (including solvents). The binder suspension comprises at least from 1% by weight to 60% by weight, particularly preferably from 5% by weight to 40% by weight, of organic binder, based on the total weight of the binder suspension, and from 0% by weight to 15% by weight, particularly preferably from 2% by weight to 10% by weight, of plasticizer, based on the total weight of the binder suspension (including solvents). The binder suspension contains a sufficient amount of solvent to at least ensure a suspension of the individual constituents of the binder suspension. The use of larger amounts of solvents than are required for suspension of the hard material particles and the solder material particles is possible. However, further binder suspension or solvent can also be added during the overall process for producing the slip if required. The amount of solvent is preferably chosen so that slips having a high solids content are formed.

Furthermore, from 40% by weight to 95% by weight, preferably from 70% by weight to 90% by weight, of hard material particles and solder particles, based on the total weight of the slip, are added to the binder suspension. The weight ratio of hard material particles to solder material particles is preferably in the range from 40:60 to 90:10, i.e. the slip preferably contains from about 25% by weight to 90% by weight, particularly preferably from 50% by weight to 80% by weight, of hard material particles and from about 5% by weight to 60% by weight, particularly preferably from 10% by weight to 40% by weight, of solder material particles. The hard material particles and solder material particles can be added together or separately. The particles can either be added as solid to the binder suspension or be added in presuspended form.

In a further embodiment in a process for producing wear protection sheets the slurry is produced using, based on the total weight of the slip, from 0.1 by weight to 30% by weight of the binder suspension containing from 0.1% by weight to 60% by weight of organic binder, based on the total weight of the binder suspension, and from 0% to 15% by weight of plasticizer, based on the total weight of the binder suspension, and from 60% by weight to 99.9 by weight of hard material particles and solder material particles, with the weight ratio of hard material particles to solder material particles being in the range from 0:100 to 100:0.

Further useful additives, in particular dispersants, antifoams or protective colloids, e.g. polyester-polyamine condensation polymers, alkyl phosphate compounds, polyvinyl alcohols, dextrins or cellulose ethers, can also be added to the slip or the binder suspension.

In tape casting by means of a slip casting process, it is possible to use conventional tape casting apparatuses. Here, the slip is introduced into a reservoir under which a plastic carrier runs continuously at a regulated speed. The slip is cast from the reservoir onto the plastic film and wiped by means of a doctor blade to a particular thickness. This produces a smooth and level sheet which is then generally dried at variable temperatures, if appropriate taken off from the plastic film and rolled up or further processed or finished. The process described displays a high production rate and thus advantageous manufacturing costs, with the quality of the sheets produced displaying a good constancy. Furthermore, different sheet thicknesses, in particular in the range from 10 μm to 3000 μm, and sheet widths can be obtained in a simple manner. The maximum sheet width is determined by the tape casting plant used. Owing to the pronounced pseudoplastic behavior of the slip, sheet widths of up to 400 mm can be produced without problems. The sheet thickness and width can be set by means of the following parameters: blade height of the doctor blade, fill height and thus casting pressure of the slip in the casting chamber, velocity of the plastic substrate, casting head width and viscosity of the slip. The sheet thickness fluctuations over the width and length are usually less than 10% in this process. If structured plastic carriers are used as casting substrate, simple structures can also be introduced into the wear protection sheet.

An alternative process is the vacuum slip casting process which is particularly suitable for producing three-dimensionally shaped wear protection sheets. In vacuum slip casting, the process is substantially accelerated by application of a reduced pressure. In this process, the slip is poured into a porous mold through which the solvent present is sucked out by means of a reduced pressure. The solids present in the slip deposit on the surface of the mold and thus form a three-dimensionally shaped sheet, which after drying can be removed from the mold. The vacuum process enables, in particular, very thin films down to a thickness of 1 μm to be obtained, and the solvent taken off can also be reused. The vacuum process can likewise be utilized industrially.

In a preferred embodiment of the production process, a suspension comprising solvent, e.g. an alkyl ketone, a binder, preferably polypropylene carbonate and a plasticizer, preferably propylene carbonate is homogenized and mixed in a ball mill for a number of days. The resulting mixture of the organic additives forms the basis of the tape casting slip. In the next step, a ball mill is filled with milling media and the binder suspension produced is weighed in. The quantity of milling media used should be chosen according to the amount of solids in the slip and the milling media should have a density higher than that of the hard material used. The hard material and solder powders are then weighed in. As hard materials, preference is given to using various nickel-encased tungsten carbides. As solder materials, use is made first and foremost of nickel/chromium solder powders, preferably NICROBRAZ solder powder (Wall Colmonoy). The slip obtained is mixed with continual stirring for from 0.5 h to 24 h. The mixed slip is then transferred to a specific casting vessel and degassed. Owing to the high density of the powders used, the slip continually has to be stirred slowly so as to avoid sedimentation of the solid constituents. The degassed slip is then cast on a commercial casting plant to give a solid and flexible hard metal sheet. As substrate, preference is given to using a plastic carrier, in particular a silicone-coated plastic film, for example a PET film, which should withstand the tensile forces during the casting process and display low adhesion to the dried slip or the green sheet, so that the latter can easily be removed again. The wet sheet produced is dried in a convection drying tunnel, preferably at temperatures in the range from 25° C. to 85° C. The process described makes it possible to produce, in particular, green sheets having a density of 2.5-15 g/cm³. The proportion of solid organic additives in the green sheet is preferably in the range from 1% by weight to 25% by weight, in particular from 2% by weight to 10% by weight, of the mass of the green sheet.

The production of wear protection sheets by means of tape casting has many advantages. Thus, for example, when using an organic binder, large amounts of hard material particles can be mixed without problems into a matrix of solder material during slip production. Use of an organic binder also stabilizes the sheet obtained, in particular in respect of mechanical stress, which increases the handleability of the sheet and in particular aids the further processing of the sheet.

The wear protection sheets described here are particularly suitable for producing wear protection layers by means of hard soldering at above 450° C., preferably by means of high-temperature soldering at above 900° C., resulting in production of a strong bond between the sheet and the component due to liquid-phase sintering which forms a diffusion zone at the interface. Particularly intimate bonds between the wear protection layer and the component are formed in this way. Liquid-phase sintering is usually carried out under protective gas and/or under reduced pressure, with a small amount of hydrogen often being mixed in as oxidation protection. Hard soldering and high-temperature soldering make it possible to coat, in particular, metallic components which have a steel surface or have a metal surface comprising, for example, iron, copper, molybdenum, chromium, nickel, aluminum, silver or gold. Here, the melting point of the surface or its solidus temperature should be above the liquidus temperature of the solder material present in the wear protection sheet.

To produce a wear protection layer, the binder-containing wear protection sheets can be applied directly to a component, subjected to binder removal and then processed further to give the appropriate protective layer. However, the wear protection sheets are preferably subjected to binder removal and pre-sintered beforehand in order to minimize the shrinkage of the sheet in the production of the wear protection layer on the component. Binder removal is the substantially residue-free removal of the organic constituents required for tape casting. If residues in the form of carbon nevertheless remain, this leads to formation of carbides in the subsequent sintering process, which does not necessarily have to be a problem. Binder removal is carried out thermally according to a suitable temperature/time profile. The temperature should not rise above 400° C. Binder removal is usually carried out under nitrogen or argon, sometimes with a small amount of hydrogen to remove any atmospheric oxygen present. Complete removal of binder from the sheet can take up to one day.

In the following, two processes for producing wear protection layers on a component are described by way of example. The first process starts out from a green hard material sheet filled with solder material. The green sheet is cut to size so as to fit the component and is applied to the surface of the component. Application of the sheet can be effected without further auxiliaries, but it is also possible to use adhesives which can preferably be removed by thermal decomposition. In particular, the binder suspension can be used as adhesive for application of the sheet to the component. The component with the green sheet is then treated thermally. In the first thermal treatment step, the binder removal process is carried out, preferably at low temperatures of less than 350° C. The binder removal temperature is, in preferred embodiments, below the liquidus temperature of the solder material in the wear protection sheet. The organic additives used are, in this step, removed to leave as little residue as possible, preferably under reduced pressure (below 1 bar). In the subsequent sintering step, the binder-free sheet is sintered onto the component surface in a high vacuum of about 10⁻⁴-10⁻⁶ mbar. The maximum temperature and the hold time depend on the solder material used, with at least the liquidus temperature of the solder material having to be reached. The liquidus temperature of the solder material should be below the melting point of the hard material. The sintering temperatures are normally in the range from 800° C. to 2000° C., in particular from 1000° C. to 1500° C., preferably from 1050° C. to 1200° C. The solder material used becomes liquid at the predetermined sintering temperature and wets the hard metal particles and the component surface. The high vacuum applied aids wetting of the hard metal particles and the support with the liquid solder and reduces the porosity in the wear protection layer produced. A pronounced diffusion layer is formed between the component surface and the wear protection layer produced. The diffusion layer determines the adhesion of the wear protection layer to the component surface.

In the second process, a pre-sintered wear protection part is produced from the flexible green sheet produced by a method analogous to the process just described. Pre-sintering of the green sheet is, for example, carried out on a ceramic sintering substrate such as Al₂O₃ or ZrO₂. After the binder removal cycle at up to 400° C., a high vacuum is applied and the hard metal sheet is sintered on the sintering substrate to form the solid particle composite. The wear protection sheet which has been pre-sintered in this way can then be applied to the component and processed to form the wear protection layer by liquid-phase sintering in a manner analogous to the above-described process. As an alternative, the pre-sintered material can also be simply adhesively bonded to the surface of the component or be welded on or soldered on using an additional solder.

The wear protection layers which can be produced by means of the wear protection sheets of the invention have a low porosity of preferably less than 5%, particularly preferably less than 1.5%, in particular less than 1%. The porosity can be determined visually on a section through a wear protection layer, with the ratio of the area of the pores to the area of the solids on the cut surface being determined.

Preferred wear protection layers which can be produced using the processes described have a density in the range from 2.5 g/cm³ to 25 g/cm³, preferably from 5 g/cm³ to 15 g/cm³. The wear protection layers produced have a high hardness. Wear protection layers having a Rockwell hardness in the range from 40 HRC to 70 HRC can be produced without problems, and preferred wear protection layers have a Rockwell hardness of above 50 HRC. The wear resistance of the layers produced can be determined by means of a two-body abrasive wear test in accordance with ASTM G132-96 (pin-on-table). The wear resistance can, for example, be determined in accordance with the standard ASTM G65-04.

In particular, the combination of organic additives, including organic binders and plasticizers, having a low decomposition temperature and solder materials having a liquidus temperature above the decomposition temperature of the organic additives enables, in combination with the metal-encased hard material particles which are uniformly distributed in the solder material matrix, wear protection layers having a low porosity and high hardness to be produced. The liquidus temperature of the solder material is preferably more than 100° C. above, particularly preferably more than 200° C. above, in particular more than 400° C. above, the decomposition temperature of the organic binder or plasticizer. This can be achieved by means of wear protection sheets which are simple to produce industrially and can easily be converted by means of thermal treatment, in particular separate binder removal at low temperatures and subsequent hard soldering, high-temperature soldering or flame soldering at high temperatures, into the respective wear protection layers.

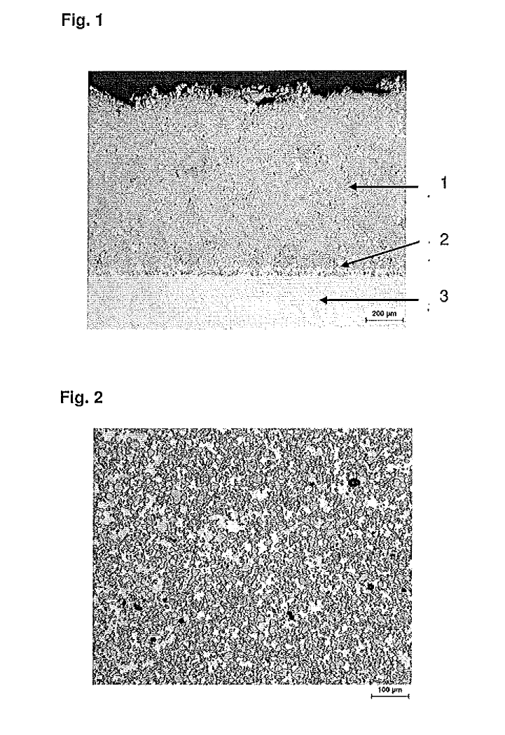

FIG. 1 shows a wear protection layer (1) comprising a NICROBRAZ solder material and nickel-encased tungsten carbide particles on a steel support (3). It can be seen from the picture in FIG. 1 that the encased tungsten carbide particles are distributed virtually uniformly in the wear protection layer and the wear protection layer produced has a low residual porosity. Furthermore, it can be seen that the diffusion layer (2) between the wear protection layer and the steel support (3) is very well pronounced.

FIG. 2 shows a pre-sintered particle composite composed of nickel-encased tungsten carbide particles and a nickel/chromium-containing solder material.

The production of a slip allows simple incorporation of metal-encased hard material particles into the solder material, so that a wear protection layer having an isotropic microstructure can be produced via production of a wear protection sheet. However, use of multilayer composite sheets makes it possible to produce wear protection layers which have a gradient in the hard material concentration. The mixture of the two starting materials, viz. the metal-encased hard material particles and the solder material, can be freely defined as a function of the particular application; in particular, high contents of metal-encased hard material particles can be introduced into the wear protection layers. The preferred organic additives, e.g. binder and plasticizer, which have a decomposition temperature below 350° C. make it possible for the binder to be removed from the green sheet without the wear protection layer or the component being damaged. The tape casting process is generally an inexpensive process for producing large-area planar components. The flexible green sheet makes a variety of different inexpensive processing steps (cutting, stamping, lamination) possible. In addition, lamination of such sheets makes it possible to produce gradients of materials in the wear protection layer. The uppermost layer can then, for example, contain more hard metal so that the wear protection properties can be greatly improved. The lowermost layer accordingly contains more solder material so that the pronounced diffusion layer ensures excellent adhesion to the component surface. The shape of the wear protection sheet can be matched in the green state to the component surface by sintering-on of the sheet in a single process step.

The invention will now be described in further detail with reference to the following non-limiting examples.

### EXAMPLES

### Example 1

### Slurry and Sheet Production

To produce the slurry, a suspension composed of 70.5% by weight of ethyl methyl ketone as solvent, 25.7% by weight of polypropylene carbonate as binder and 3.8% by weight of propylene carbonate as plasticizer are homogenized and mixed in a ball mill for a number of days. The resulting mixture of the organic additives forms the basis of the tape casting slip. Table 1 shows the composition of the binder suspension.

TABLE 1
Binder suspension

| Designation | Material | % by mass | % by volume |
|---|---|---|---|
| Solvent | MEK | 70.5 | 79.2 |
| Binder | polypropylene carbonate | 25.7 | 17.9 |
| Plasticizer | propylene carbonate | 3.8 | 2.9 |

In the next step, a ball mill is filled with milling media and the binder suspension produced is weighed in according to the prescribed formulation. The hard metal powder and solder powder are then weighed in according to the prescribed formulation. An Ni-encased tungsten carbide WC-Ni 88-12 (H.C. Starck, Germany) is used as hard metal powder. A NICROBRAZ solder powder from Wall Colmonoy is used as solder powder. Table 2 shows the slip composition used for producing a wear protection sheet having a mixing ratio of 65:35 of hard metal powder to solder powder.

TABLE 2
Slurry

| Designation | Material | % by mass | % by volume |
|---|---|---|---|
| Binder suspension | MEK; PPC; PC | 13.5 | 66.5 |
| Hard metal | WC-Ni 88-12 impermeably | 56.2 | 16.5 |
| powder | encased | | |
| Solder powder | NICROBRAZ | 30.3 | 17.0 |

The slip is mixed at a rotation rate of 20-30 rpm for 12-16 h. The mixed slip is then transferred to a special casting vessel and degassed at a reduced pressure of 500 mbar for 15 minutes. The slip is then cast on a conventional casting unit to produce a solid and flexible hard metal sheet. The slip is cast onto a silicone-coated carrier film.

The wet sheet produced is dried in a convection drying tunnel. The green hard metal sheet has no cracks. The density of the green sheet is 4.5-5.8 g/cm³. The proportion of solid organic additives in the green sheet is 4-5% by mass.

### Example 2

### Production of Wear Protection Layers

The wear protection layers on a component can be produced by means of two different processes.

2.1 The first process starts out from one of the green hard metal sheets filled with solder material which have been produced as described in example 1. The green sheet is cut to size to match the component size and applied to the component surface of a steel support. The organic additives present in the green sheet are then removed under reduced pressure at a temperature of up to 350° C. In the subsequent liquid-phase sintering step, the binder-free sheet is sintered onto the component surface at a sintering temperature of about 1180° C. in a high vacuum of 10⁻⁵ to 10⁻⁶ mbar over a period of about 30 minutes. A pronounced diffusion layer is formed between the component surface and the wear protection layer produced. The ratio of hard metal to solder material is 70:30% by mass. The density of the particle composite is 10.4 g/cm³.

FIG. 1 shows the wear protection layer comprising the NICROBRAZ solder material and tungsten carbide on a steel support as produced in Example 2.1. It can be seen that the residual porosity is less than 1% and the diffusion layer between the wear protection layer and the steel support is very well pronounced.

The wear protection layer produced has a hardness of 60 HRC (Rockwell hardness). To determine the wear resistance of the layers produced, a two-body abrasive wear test in accordance with ASTM G132-96 (pin-on-table) was carried out. The volume of material removed is 0.68 mm³ (flint) or 12.27 mm³ (SiC). The wear resistance of the layers produced is thus high.

2.2 In the second process, a pre-sintered wear protection part is produced in a first step from the flexible green sheet produced as described in Example 1. The organic additives are burnt out at up to about 350° C. in this step. Pre-sintering of the green sheet is carried out on a ceramic Al₂O₃ sintering substrate in a high vacuum of 10⁻⁶ mbar at a temperature of 1065° C. over a period of 20 minutes. The pre-sintered particle composite of tungsten carbide and the NICROBRAZ solder material is shown in FIG. 2, The sheet is then cut to size and applied to a steel support. Sintering of the pre-sintered sheet is subsequently carried out on the sintering substrate in a 30-minute liquid-phase sintering step in a high vacuum of from 10 mbar to 10⁻⁶ mbar at a sintering temperature of about 1180° C. to give the solid particle composite. It has been found that the use of the pre-sintered wear protection sheet significantly reduces the shrinkage of the protective layer as a result of liquid-phase sintering.

It will be appreciated by those skilled in the art that changes could be made to the embodiments described above without departing from the broad inventive concept thereof, It is understood, therefore, that this invention is not limited to the particular embodiments disclosed, but it is intended to cover modifications within the spirit and scope of the present invention as defined by the appended claims.

What is claimed is:

1. A wear protection sheet comprising hard material particles having a metallic shell and solder material particles selected from the group consisting of soft solders, hard solders and high-temperature solders.

2. The wear protection sheet according to claim 1, further comprising at least one additional component selected from the group consisting of organic binders, organic plasticizers, and mixtures thereof.

3. The wear protection sheet according to claim 2, wherein the at least one additional component has a decomposition temperature below 400° C.

4. The wear protection sheet according to claim 2, wherein the at least one additional component comprises a polypropylene carbonate and/or a propylene carbonate.

5. The wear protection sheet according to claim 1, wherein the hard material particles comprise one or more hard materials selected from the group consisting of tungsten carbides, titanium carbides, tantalum carbides, silicon carbides, vanadium carbides, chromium carbides, molybdenum carbides, titanium borides, fused tungsten carbides, fused tungsten carbides having a tungsten carbide shell or a shell of chromium carbides, and mixtures thereof.

6. The wear protection sheet according to claim 1, wherein the metallic shell comprises one or more metals selected from the group consisting of nickel, cobalt, chromium, copper, molybdenum, aluminum, yttrium, iron, and mixtures thereof.

7. The wear protection sheet according to claim 1, wherein the hard material particles have a spherical shape.

8. The wear protection sheet according to claim 1, wherein the solder material particles comprise one or more solder materials selected from the group consisting of nickel, cobalt, copper, tin, and silver solders.

9. The wear protection sheet according to claim 1, wherein the solder material particles comprise a nickel/chromium solder material or a nickel/cobalt solder material.

10. The wear protection sheet according to claim 1, wherein the hard material particles are present in an amount of about 5% by weight to about 95% by weight, wherein the solder material particles are present in an amount of about 5% by weight to about 95% by weight, and wherein the sheet further comprises 0 to about 20% by weight of at least one additional component selected from the group consisting of organic binders, organic plasticizers, and mixtures thereof.

11. A multi-layer composite having at least one layer comprising a wear protection sheet according to claim 1, wherein the at least one layer and an additional layer contain different proportions of hard material particles and/or solder material particles.

12. A process for producing a wear protection sheet, the process comprising:
(a) providing a binder suspension comprising a solvent and an organic binder;
(b) admixing the binder suspension with (i) hard material particles and (ii) solder material particles selected from the group consisting of hard solders and high-temperature solders, to form an admixture, and processing the admixture to produce a slip; and
(c) casting the slip to produce the wear protection sheet.

13. The process according to claim 12, wherein the hard material particles and solder material particles are present in an amount of about 70% by weight to about 95% by weight, based on the total weight of the slip, and at a weight ratio of hard material particles to solder material particles of 40:60 to 90:10; and wherein the binder suspension is present in an amount of about 5% by weight to about 30% by weight, based on the total weight of the slip, the binder suspension comprising about 1% by weight to about 60% by weight of organic binder, based on the total weight of the binder suspension, and from 0% by weight to about 15% by weight of plasticizer, based on the total weight of the binder suspension.

14. The process according to claim 13, wherein the binder is removed at a temperature below 400° C., and the wear protection sheet is optionally pre-sintered.

15. A method for producing a wear protection layer on a component, the method comprising applying a wear protection sheet according to claim 2 to a surface of a component.

16. The method according to claim 15, wherein the binder-containing wear protection sheet is applied directly to the component and is then subjected to binder removal at temperatures below 400° C., or is subjected to binder removal at temperatures below 400° C. and then pre-sintered before application to the component and the wear protection layer is subsequently produced on the component by liquid-phase soldering.

17. A method or producing a wear-protected component, the method comprising applying a pre-sintered wear protection sheet according to claim 13 to a component surface by soldering, adhesively bonding or welding.

18. A wear protection sheet comprising: 0.1% by weight to 99.9% by weight of hard material particles having a metallic shell; 0.1% by weight to 99.9% by weight of solder material particles selected from the group consisting of soft solders, hard solders and high-temperature solders; and 0.1% by weight to 20% by weight of at least one additional component selected from the group consisting of organic binders, organic plasticizers, and mixtures thereof; all percentages by weight based on total weight.

19. A multi-layer composite having at least one layer comprising a wear protection sheet according to claim 19, wherein the at least one layer and an additional layer contain different proportions of hard material particles and/or solder material particles.

20. A process for producing a wear protection sheet according to claim 18, the process comprising:
(a) providing a binder suspension comprising a solvent and an organic binder;
(b) admixing the binder suspension with (i) hard material particles and (ii) solder material particles selected from the group consisting of hard solders and high-temperature solders, to form an admixture, and processing the admixture to produce a slip; and
(c) casting the slip to produce the wear protection sheet;
wherein the hard material particles and solder material particles are present in an amount of about 60% by weight to about 99.9% by weight, based on the total weight of the slip, and at a weight ratio of hard material particles to solder material particles of 0:100 to 100:0; and wherein the binder suspension is present in an amount of about 0.1% by weight to about 30% by weight, based on the total weight of the slip, the binder suspension comprising about 0.1% by weight to about 60% by weight of organic binder, based on the total weight of the binder suspension, and from 0% by weight to about 15% by weight of plasticizer, based on the total weight of the binder suspension.
